(19) United States
(12) Patent Application Publication
(10) Pub. No.: US 2016/0234363 A1
(43) Pub. Date: Aug. 11, 2016

(54) Modular Portable Cellular Device Layout and Connection System

(71) Applicant: Motorola Mobility LLC, Chicago, IL (US)

(72) Inventors: Michael J. Lombardi, Lake Zurich, IL (US); Joseph L. Allore, Mundelein, IL (US); Paul L. Fordham, Wauconda, IL (US)

(21) Appl. No.: 14/615,519

(22) Filed: Feb. 6, 2015

(51) Int. Cl. H04M 1/02; H04M 1/725

(52) U.S. Cl. CPC H04M 1/0274; H04M 1/0249; H04M 1/0254; H04M 1/72527

(57) ABSTRACT

An expandable cellular phone includes system for allowing the cellular phone to physically mate with, and electronically link to, an independently functional auxiliary module. The system includes a contact face on a backside of the device to mate to a corresponding back face of the auxiliary module. The back face of the expandable cellular phone includes at least one electrical contact at a location mirroring a location of a mating electrical contact on the corresponding face of the auxiliary module. Moreover, at least two locating points are provided on the back sides if both devices, with each locating point on one device including a locating pin, and each corresponding locating point on the other device including a receptacle for the locating pin.

### TECHNICAL FIELD

The present disclosure is related generally to mobile device configuration, and, more particularly, to a layout and connection system and method for a portable cellular device.

### BACKGROUND

The seemingly endless quest to lighten the average cell phone finally reached a stable lower limit in 2000, with the average cellular phone, then and now, coming in at about 4 ounces. That weight is about one tenth of the weight of the first commercial cellular phone.

The search for the optimal phone thickness took slightly longer, with cellular phones losing more than half of their thickness in the last decade alone. Considerations such as durability and hand feel would indicate that the industry has arrived at the ideal thickness (slightly under 10 mm) just within the past few years.

Nonetheless, as cellular phones continue to displace more traditional devices for productivity and entertainment, the number of features and functions demanded by users has grown enormously. As an example, even the television has been somewhat displaced by the cellular phone. Fully 75% of juveniles watch short content on a portable device, and 50% of them even watch full-length programming on their devices. The latter figure represents an increase of almost 25% in just one year.

With functions like video entertainment, audio entertainment, photography, scheduling and gaming migrating to the mobile platform, it has become increasingly difficult for manufacturers to keep the weight and size of cellular devices within the ideal limits arrived at in the last decade.

While modularity offers the hope of a solution, modular designs have generally increased the size and weight of the device. As such, modular designs have had only limited appeal to end users. Compounding the size and weight issues, the various modules in a typical modular design have no use other than as part of a combined device. That is, they have limited or no functionality when apart.

While the present disclosure is directed to a system that can eliminate some of the shortcomings noted in this Background section, it should be appreciated that any such benefit is not a limitation on the scope of the disclosed principles, nor of the attached claims, except to the extent expressly noted in the claims. Additionally, the discussion of technology in this Background section is reflective of the inventors' own observations, considerations, and thoughts, and is in no way intended to accurately catalog or comprehensively summarize the prior art. As such, the inventors expressly disclaim this section as admitted or assumed prior art with respect to the discussed details. Moreover, the identification herein of a desirable course of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example device with respect to which embodiments of the presently disclosed principles may be implemented;

FIG. 2 is a simplified side view schematic of a portable electronic device or module in accordance with an implementation of the disclosed principles;

FIG. 3 is a simplified back view of the portable electronic device of FIG. 2 within which embodiments of the disclosed principles may be implemented;

FIG. 4 is a simplified back view schematic of a second portable electronic device configured to mate with and interoperate with the device of FIGS. 1-3;

FIG. 5 is a cross-sectional side view showing certain components of a magnetic alignment system in accordance with an embodiment of the disclosed principles; and

FIG. 6 is a cross-sectional side view showing certain components of a spring-loaded contact system in accordance with an embodiment of the disclosed principles.

### DETAILED DESCRIPTION

Before presenting a detailed discussion of embodiments of the disclosed principles, an overview of certain embodiments is given to aid the reader in understanding the later discussion. In an embodiment of the disclosed principles, a modular portable electronic device configuration is provided having low weight and size and allowing substantially extended functionality without overly increasing device size or weight. In this embodiment, the primary device or first module has a front surface and a back surface, and contains a battery and a printed circuit board (PCB). It may also include functional components other than those for cellular communication, e.g., a camera, a flash LED, a speaker, a microphone, a memory card reader, an LED, a button, a vibrator, and short range wireless connectivity.

A second device also includes a battery and a main PCB, and may include a display, touchscreen, and cellular connectivity for example. It may also include other components, e.g., a front camera, a rear camera, a flash LED, a speaker, a microphone, buttons, a vibrator, and short range wireless connectivity. In an embodiment, the second device includes components such as ferrous plates, alignment holes, and contact pads to mate with corresponding magnets, pins, and spring contacts on the first device.

Both devices are independently functional but, when mated, form a more powerful, more functional cellular device. For example, the first device alone may be able to function as a short range wireless speaker system or a portable digital camera while the second device alone may be able to fully function as a cellular phone or other portable device. Together, the first and second devices create a cellular phone with better battery life, better audio performance, additional cameras, and a new physical appearance.

The mating components on the devices include, for example, magnets, pins, and spring contacts on or protruding from a surface of the first device and an array of contact pads, ferrous steel discs and alignment holes on a surface of the second device. When the devices are faced to one another and the contacting face of the first device is properly aligned to the contacting face of the second device, the array of spring contacts make contact with the array of contact pads, the magnets are attracted to the ferrous discs, and the alignment pins drop into the alignment holes.

The magnets in the array are strong enough to counteract the contact force exerted by the array of contact pins from the first device making contact with the array of contact pads or pucks on the second device. In an embodiment, the array of magnets is grounded to the first device and the array of steel discs is grounded to the second device, such that when the two devices are magnetically attached to one another, there is a ground path between the devices through the magnets and steel discs.

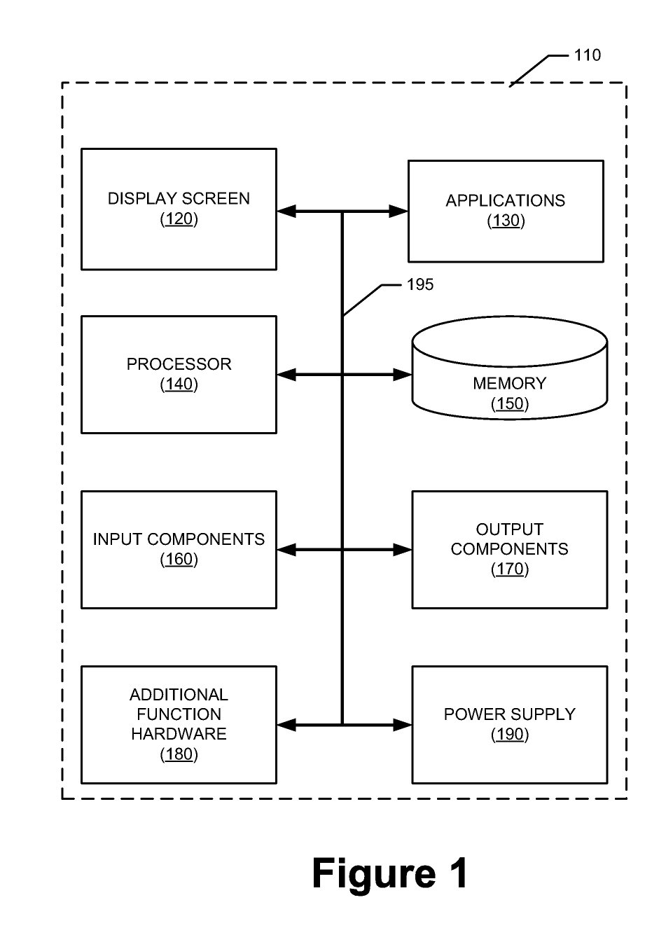

With this overview in mind, and turning now to a more detailed discussion in conjunction with the attached figures, the techniques of the present disclosure are illustrated as being implemented in a suitable computing environment with respect to one or more of the stand-alone modules discussed herein. The following device description is based on embodiments and examples of the disclosed principles and should not be taken as limiting the claims with regard to alternative embodiments that are not explicitly described herein. Thus, for example, while FIG. 1 illustrates an example mobile device or module within which embodiments of the disclosed principles may be implemented, it will be appreciated that other device types may be used, including but not limited to tablet computers and other portable devices.

The schematic diagram of FIG. 1 shows an exemplary set of components 110 forming part of an environment within which aspects of the present disclosure may be implemented. It will be appreciated that additional or alternative components may be used in a given implementation depending upon user preference, component availability, price point, and other considerations.

In the illustrated embodiment, the set of components 110 include a display screen 120, applications (e.g., programs) 130, a processor 140, a memory 150, one or more input components 160 such as speech and text input facilities, and one or more output components 170 such as text and audible output facilities, e.g., one or more speakers.

The processor 140 can be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of an electronic device. Such functions may include, for example, interaction among various internal components and storage and retrieval of applications and data to and from the memory 150.

Further with respect to the applications, these typically utilize the operating system to provide more specific functionality, such as file system service and handling of protected and unprotected data stored in the memory 150. Although many applications may provide standard or required functionality of a user device, in other cases applications provide optional or specialized functionality, and may be supplied by third party vendors or a device manufacturer.

Finally, with respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

Although not shown, the set of components 110 may include software and hardware networking components to allow communications to and from a device. Such networking components will typically provide wireless networking functionality, although wired networking may additionally or alternatively be supported.

In an embodiment, a power supply 190, such as a battery or fuel cell, may be included for providing power to the set of components 110. All or some of the internal components communicate with one another by way of one or more shared or dedicated internal communication links 195, such as an internal bus.

In an embodiment, the set of components 110 are programmed such that the processor 140 and memory 150 interact with the other components to perform a variety of functions. The processor 140 may include or implement various modules and execute programs for initiating different activities such as launching an application, transferring data, and toggling through various graphical user interface objects (e.g., toggling through various display icons that are linked to executable applications).

In a further embodiment of the disclosed principles, the illustrated set of components 110 includes one or more additional hardware groups 180. These additional hardware groups 180 include hardware supporting additional, with the software for such functions being included in the applications 130 and/or memory 150. Examples of such other functions include still or video camera, rear camera, flash LED, speaker, microphone, buttons, a phone vibrator, short range wireless connectivity, and so on.

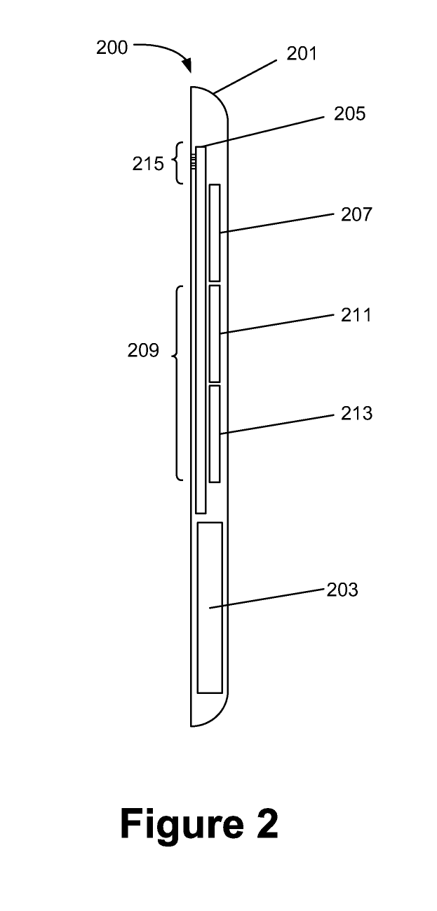

Turning to FIG. 2, this figure presents a simplified side view schematic of a portable electronic device or module 200 in accordance with an implementation of the disclosed principles. In the illustrated example, the device 200 includes a housing 201, within which are located a battery 203), as well as a PCB 205. The PCB 205 may be a single-sided or double-sided board, and may host a number of circuit components such as a processor 207, and one or more memory integrated circuits (ICs) 209, including RAM 211 and ROM 213 ICs or circuits.

For connecting to a second device or module, the illustrated device 200 includes an array of contacts 215. The contacts are electrically connected to convey data, commands, or other electrical information or signals to or from the PCB 205, which, through its printed leads, communicates information and signals to and from the appropriate components on the board 205.

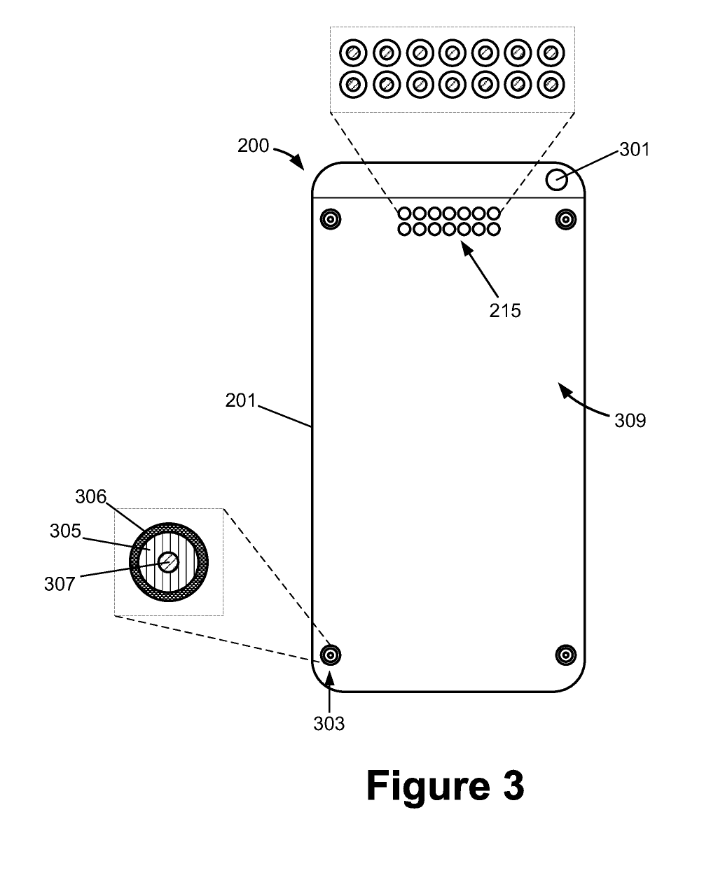

Continuing, FIG. 3 is a simplified back view of the portable electronic device 200 of FIG. 2. The device 200 includes, in this view, the housing 201 and the array of contacts 215. In addition, a hole 301 is shown through the housing 201 in this view.

Further with respect to the modular nature of the system formed by the device 200 and another device, the back of the device 200 includes a number of magnet assemblies 303, comprising a ring magnet 305, an outer ferrous shroud 306 surrounding the magnet, and an alignment pin 307 in the central opening of the ring magnet. The alignment pin 307 may be fabricated as part of the outer ferrous shroud 306 or they may be separate pieces.

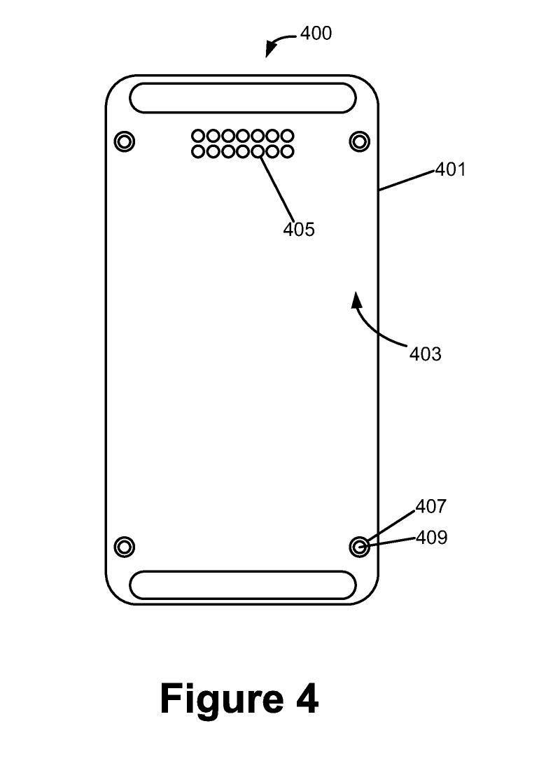

FIG. 4 shows a simplified back view schematic of a second portable electronic device 400 comprising the set of components 110 from FIG. 1 and configured to mate with and interoperate with the device 200 of FIGS. 2 and 3. Although not illustrated, it will be appreciated that the second portable electronic device 400 includes, internally, a power source such as a battery, and a PCB. Appropriate ICs and electrical components or circuit elements are mounted on or in association with the PCB to support independent operation of the second portable electronic device 400, as well as interoperation with the first device 200.

In this regard, the functions of the second device 400 may, but need not, overlap those of the first device 200. For example, both devices 200, 400 may include a first function, such as a camera, while only the second device 400 includes the necessary hardware and software to support a second function, e.g., short range wireless connectivity. However, in an embodiment, the combined device may use the capabilities and power source of either device 200, 400 when the devices 200, 400 are connected.

To facilitate interconnection, the back surface 403 of the housing 401 of the second portable electronic device 400 includes an array of contact pucks 405 configured and positioned to mate in a one-to-one fashion with the array of contacts 215 located on the back of the first device 200 when the first device housing 201 and the second device housing 401 are mated with the housing edges substantially aligned.

In order to attach the first 200 and second 400 devices, the back surface 403 of the housing 401 of the second device 400 includes a number of ferrous discs 407, with each ferrous disc 407 having an alignment hole 409 therein. For linked operation, the back surfaces 309, 403 of the first 200 and second 400 devices respectively are roughly aligned and then placed in contact. As the devices 200, 400 are placed into contact, the alignment pins 307 of the first device 200 enter the alignment holes 409 in the second device 400. In this configuration, each contact 215 of the first device 200 is in electrical contact with a corresponding contact puck 405 of the second device 400.

Moreover, in this configuration, each ferrous ring 407 of the second device is magnetically linked to a corresponding magnet assembly 303 of the first device 200. As noted above, the cumulative magnetic force thus created in an embodiment is sufficient to overcome spring-loading that may be used in the contacts 215 to assure contact with the contact pucks 405 of the second device 400.

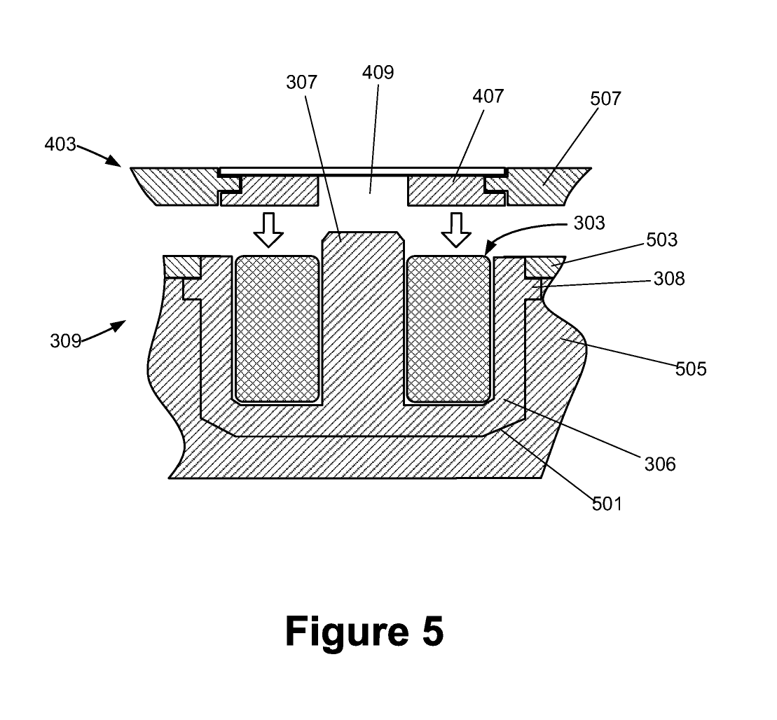

Although any suitable alignment mechanism may be used, FIGS. 5 shows the components of an example magnetic alignment system. A portion of the back 309 of the first device 110 is shown adjacent a portion of the back 403 of the second device 400. As noted with respect to FIG. 3, the back 309 of the first device 110 includes a plurality of magnet assemblies 303, comprising a ring magnet 305, an outer ferrous shroud 306 surrounding the magnet, and an alignment pin 307 in the central opening of the ring magnet. The entire magnet assembly 303 is retained in the back surface of the first device 200 using a flange 308 protruding from the shroud 306.

As noted with respect to FIG. 4, a plurality of ferrous discs 407 are retained in the back surface 403 of the second device 400. Each ferrous disc 407 includes an alignment hole 409 for receiving the alignment pin 307 of the ring magnets 303 on the back surface 309 of the first device 110.

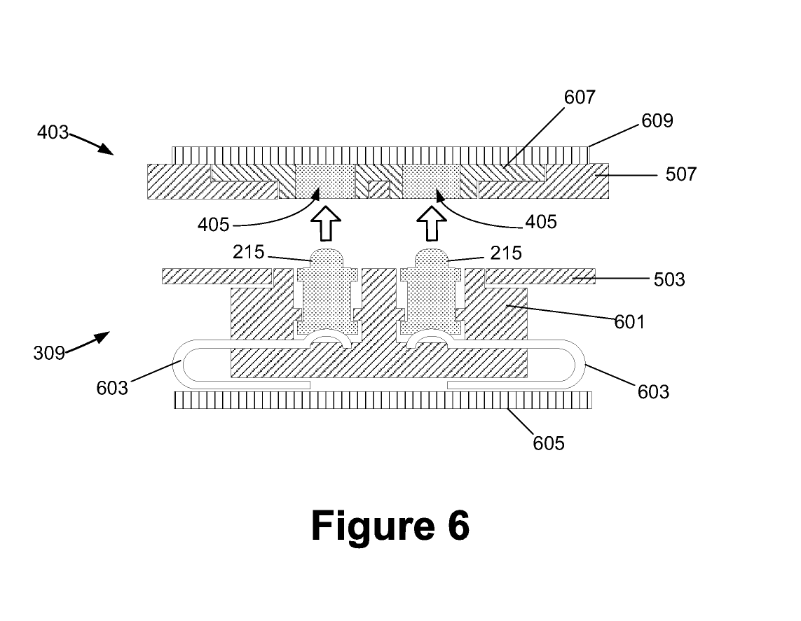

Using an alignment and retaining mechanism such as that described by reference to FIG. 5, the contacts and contact pucks shown in FIGS. 3 and 4 can be accurately mated as well. Turning to FIG. 6, a more detailed view of the described contact system is shown. In particular, FIG. 6 is a more detailed cross-sectional view of two contacts 215 and two mating contact pucks 405, with additional detail regarding mounting as well.

The back surface 309 of the first device includes a contact assembly having an electrically insulting retainer block 601, which may comprise plastic, resin, ceramic or other suitable material. The retainer block 601 retains the contacts 215 in a sliding relationship thereto, such that the contacts are free to slide between stops in a direction perpendicular to the back surface 309. A contact spring 603 biases each contact 215 outward of the back surface 309. The contact springs 603 are connected to circuitry on the first device PCB 605.

Similarly, the back surface 403 of the second device 400 includes an insulating contact puck retainer 607, which may be overmolded of plastic, which surrounds each contact puck 405 and insulates it from the backing 507, which may be metal. The contact pucks 405 receive the corresponding contacts 215 of the first device 110. Each contact puck 405 is connected to circuitry on the second device PCB 609. In this way, when the first device 200 and the second device 400 are mated, as defined by the alignment pins 307 and corresponding ferrous discs 407, as shown in FIG. 5, the contacts 215 of the first device 200 are mated with the corresponding contact pucks 405 of the second device 400.

It will be appreciated that a modular portable cellular device layout and connection system have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof

1. A portable modular electronic device comprising:
a first electronic device module having a first thickness, a first width greater than the first thickness, and a first length greater than the first width, the first electronic device module also having a first face perpendicular to the first thickness, and having one or more contact points and two or more locating points on the first face, the first electronic device module being configured to independently provide at least a first user; and
a second electronic device module having a second thickness, a second width greater than the second thickness, and a second length greater than the second width, the second electronic device module also having a second face perpendicular to the device thickness, and having one or more contact points and two or more locating points on the second face, and an electronic display on a third face parallel to and opposite the second face, the second electronic device module being configured to independently provide at least a second user function,
wherein the locations of the contact points and locating points on the first face coincide with the locations of the contact points and locating points on the second face, such that the first and second electronic device modules join together at the first and second faces to become physically joined and electronically linked, wherein the second electronic device module is configured to control the first electronic device module when the first and second electronic device modules are joined together at the first and second faces.

2. The portable modular electronic device in accordance with claim 1, wherein the first user function interacts with a user via the electronic display of the second electronic device module when the first and second electronic device modules are joined together at the first and second faces.

3. (canceled)

4. The portable modular electronic device in accordance with claim 1, wherein each of the first and second electronic device modules comprises a power source and controller.

5. The portable modular electronic device in accordance with claim 4, wherein the first and second electronic devices share at least one of power and control when the first and second electronic device modules are joined together at the first and second faces.

6. The portable modular electronic device in accordance with claim 1, wherein each electronic device module is configured to function independently of the other electronic device module as at least one of a camera, a speaker, a microphone, a memory card reader and a networked module.

7. The portable modular electronic device in accordance with claim 1, wherein the electronic display of the second electronic device module is a touch screen display.

8. The portable modular electronic device in accordance with claim 1, wherein the second electronic device module comprises a cellular connection circuit.

9. The portable modular electronic device in accordance with claim 1, wherein the one or more locating points of at least one of the first and second electronic device modules include at least one of magnets, ferrous plates, and alignment holes.

10. The portable modular electronic device in accordance with claim 1, wherein the one or more contact points of one of the first and second electronic device modules includes a spring-loaded moving contact at a contact location, and the other of the first and second electronic device modules includes a contact pad at a location coinciding with the contact location when the first and second electronic device modules are joined together at the first and second faces.

11. The portable modular electronic device in accordance with claim 1, wherein the first electronic device module is configured to function independently as one of a speaker system and a portable digital camera.

12. The portable modular electronic device in accordance with claim 1, wherein the second electronic device module is configured to function independently as a cellular phone.

13. An expandable portable cellular device comprising:
a processor and an electronic display;
a power source configured to power the processor and the electronic display; and
a housing having a thickness, and a width that is greater than the thickness, and having a length that is greater than the width, and having a contact face spanning substantially the housing width and length and having thereon at least one contact point and at least two locating points, the at least one contact point and at least two locating points being configured and located so as to mate with at least one corresponding contact point and at least two corresponding locating points respectively on a face of an auxiliary device when the auxiliary device is mated to the expandable portable cellular device at the contact face, wherein the processor is configured to control a function of the auxiliary device when the auxiliary device is mated to the expandable portable cellular device at the contact face.

14. (canceled)

15. The expandable portable cellular device in accordance with claim 13, wherein the expandable portable cellular device is configured to utilize a power source within the auxiliary device when the auxiliary device is mated to the expandable portable cellular device at the contact face.

16. The expandable portable cellular device in accordance with claim 13, wherein the controller is configured to use a function of the auxiliary device when the auxiliary device is mated to the expandable portable cellular device at the contact face, the function being one or more of a camera function, a speaker function, a microphone function, a memory card reading function, a speaker function and a networking function.

17. The expandable portable cellular device in accordance with claim 16, wherein the expandable portable cellular device includes a cellular connection circuit.

18. The expandable portable cellular device in accordance with claim 13, wherein each of the locating points includes at least one of a magnet, a ferrous plate, and an alignment hole.

19. The expandable portable cellular device in accordance with claim 13, wherein the at least one contact point includes one of a spring-loaded moving contact and a contact pad.

20. A method of configuring an independently functional cellular phone to mate physically and electronically to an independently functional auxiliary module, the method comprising, in any order:
constructing a housing for the cellular phone, the housing having circumferential edges and a display face configured to expose an electronic display to a user, and having a contact face on an opposite side of the housing for mating to a corresponding face of the auxiliary module, the first and second faces together covering substantially all of the external area of the housing except for the circumferential edges;
providing at least one electrical contact within the contact face at a location mirroring a location of a mating electrical contact on the corresponding face of the auxiliary module; and
providing at least two locating points within the contact face at locations mirroring the locations of at least two mating locating points on the corresponding face of the auxiliary module; and
installing a processor within the housing, the processor being configured to utilize the function of the independently functional auxiliary module.
